(19) United States
(12) Patent Application Publication
(10) Pub. No.: US 2002/0073138 A1
(43) Pub. Date: Jun. 13, 2002

(54) De-identification and linkage of data records

(76) Inventors: Eric S. Gilbert, San Francisco, CA (US); Kathi S. Evans, Alameda, CA (US); Troy S. Clark, Gilbert, AZ (US); Karl Beck, Glendale, AZ (US)

Correspondence Address: THOMASON, MOSER & PATTERSON, LLP, Suite B, 4149 El Camino Way, Palo Alto, CA, 94306-4036, US

(21) Appl. No.: 09/930,829

(22) Filed: Aug. 15, 2001

Related U.S. Application Data
(60) Provisional application No. 60/254,190, filed on Dec. 8, 2000.

(51) Int. Cl. G06F 15/16

(52) U.S. Cl. 709/201

(57) ABSTRACT

Apparatus and method for creating de-identified and linked records is described. More particularly, data records are de-identified at a client computer. De-identification includes field-level one-way encryption. De-identified records may then be sent to a server computer for linkage. Linkage is done using match codes created for such data records at the client computer. The server computer is configured to provide longitudinal linkage of de-identified client records to de-identified master records. In this manner, privacy may be maintained at the client computer prior to transmission of information, and longitudinal linkage of records may occur without exposing personally identifying information.

### CROSS REFERENCE TO RELATED APPLICATIONS

This application claims benefit of United States provisional patent application serial No. 60/254,190, filed Dec. 8, 2000, which is herein incorporated by reference as though fully set forth herein.

### BACKGROUND OF THE DISCLOSURE

1. Field of the Invention

The present invention relates generally to de-identification and data record linkage, and more particularly to de-identification of a data record at a client and linkage of such a de-identified data record at a server.

2. Description of the Background Art

In recent years, the effects of the communication revolution have been felt by society. Information is proliferated at incredible rates. Computers have enabled us to compile large amounts of data and to organize and interrelate such compiled data. However, this communication revolution has not been without a price, namely, the risk of loss of an individual's privacy.

For example, hospitals, laboratories, banks, telecommunication companies, insurance companies, retailers and marketing companies, to name just a few, routinely collect and record data on individuals. More specifically, government programs, such as census taking, vital records management and labor and statistics administration, collect and extensively use data taken based on individuals. This data may be referenced and cross-referenced and sorted in a variety of manners and linked to individuals.

Entire industries, what is known as “informatics”, have arisen owing to data collection, including data warehousing, data mining and data marketing, among others. Organizations are becoming much more aware of the value of data, including its particular uses. For example, public health research advances have benefited from record linkage systems, including epidemiological findings. It stands to reason that there are major benefits to be obtained by collecting and linking or otherwise associating data records. However, the actual and potential impact on the lives of individuals based on this collected information can be harmful, ranging from annoyance of unsolicited email to profound hardships of employment denial. Therefore, there exists a need to be able to collect and process data records without exposing individuals to losses of privacy. Accordingly, it would be desirable to provide method and apparatus for “de-identification” of electronic records that retains linkage characteristics without retaining personal identifying information allowing organizations to use such data collections without violating personal privacy rights or confidentiality status of such information.

“De-identification” refers to a process of creating data records with no information that directly allows an entity's identity, such as an individual's identity, to be disclosed, namely, no “personally identifiable” information. More particularly, de-identification is conventionally defined as removal, generalization or replacement of all explicit “personally identifiable” information from data records. Examples of personally identifiable information include social security number (SSN), name, address, date of birth, phone number and other identification references pertaining to an individual's identity. Irreversible de-identification refers to an inability to re-identify a data record to a specific individual associated with that data record by means of “reverse engineering,” including but not limited to decoding, deciphering or decrypting, the removal, generalization or replacement of explicit personally identifiable information.

It should be understood that de-identification of data records does not necessarily guarantee such records will remain anonymous. For example, if a record is stripped of all explicit personal identifiers and is not stripped of the person's zip code, gender and occupation, and it turns out that the individual is from a small town where there is only one female piano teacher, it may be inferred as to whom the record belongs. De-identification methods generally fall into one of four categories namely, role-based access control, suppression or removal, generalization or aggregation, and replacement.

Role-based access control refers to a process of storing records that include personally identifiable information but access to such records by system of user permissions and disclosure rules. A problem with this method is that it is vulnerable to inappropriate disclosure sensitive information. Because of this high-risk, research requests for access to a role-based access control system are often denied.

Suppression or removal refers to a process of physically removing personally identifiable data values from record. A problem with this method is a loss of data needed for matching purposes. In some instances, non-personal identifiers are placed in records before data is removed to aid in linkage. However, this is only beneficial with a specific data source. It does not solve the problem of how to link data records across multiple data sources that generate different non-personal identifiers.

Generalization or aggregation refers to changing informational content in one or more personally identifiable fields to make a record like one of many others in a larger pool of records. For example, one might drop the last two digits of a zip code and change date of birth to year of birth. A problem with this method is that either original identifying data is retained somewhere that provides the same disclosure risk associated with role-base access control, or original identifying data is not retained and data needed to link records is absent.

Replacement refers to physical transformation or encryption of personally identifiable data to some other string of characters that is not personally identifiable. Such transformation may be one-way or two-way. Two-way refers to use of algorithms and encryption keys that, when known, can transform personal data to non-identifiable data and non-identifiable data back to person-identifiable data. A problem with this method is that encryption keys can be stolen or inappropriately used to disclose identities of people through use of known message digests or formulas. One-way encryption refers to use of an algorithm that is computationally infeasible to reverse. A one-way encryption algorithm may not feasibly be reversed through use of a key or message digest. Heretofore, linkage of data records using one-way encrypted or one-way hashed data was a problem.

Accordingly, providing method and apparatus for de-identification and linkage of records for creating anonymous though longitudinally linked records at a personal information level is desirable. By longitudinal, it is meant linking of one or more data records from one or more data sources, where such one or more data records may be created over a period of time.

### SUMMARY OF THE INVENTION

The present invention provides method and apparatus for transforming personal identifying information into match codes for subsequent record linkage. More particularly, a method for transforming personal identifying information to facilitate protection of privacy interests while allowing use of non-personally identifying information is provided. Data for an individual including personally identifying information is de-identified or depersonalized at a client computer to create anomimity with respect to such record. The de-identification includes field-level one-way encryption. The de-identified data may then be transmitted to a server computer for record linkage. Match codes, created for the data at the client computer, are used to link records at the server computer.

Another aspect of the present invention is a system comprising client computers having one or more data records. The client computers are configured to field-level normalize and one-way encrypt one or more fields of the one or more data records to provide one or more de-identified records and may be put in communication with a network for transmission of the one or more de-identified records. A server computer in communication with the network to receive the one or more de-identified records is in communication with a database including one or more master records. The server computer is configured to compare the one or more de-identified records with the one or more master records and to determine which records of the one or more de-identified records and the one or more master records are to be linked.

Another aspect of the present invention is a method for de-identification of at least one record by a programmed client computer. More particularly, at least one record having data fields is obtained, and at least a portion of the data fields are normalized. A one-way hashing of the portion of the data fields is done to encrypt personal identifying information and to provide a de-identified record.

Another aspect of the present invention is a method for linkage of de-identified records. More particularly, client de-identified records comprising field-level one-way hashed match codes are obtained. A database of master de-identified records comprising field-level one-way hashed match codes is provided. The match codes of the client de-identified records and the master de-identified records are compared. At least a portion of the client de-identified records are linked with the master de-identified records using comparison of the match codes.

Another aspect of the present invention is a system comprising a data warehouse having at least one database including master de-identified records and de-identified records longitudinally linked to at least a portion of the master de-identified records. There is at least one server computer in communication with the data warehouse and at least one customer computer in communication with the at least one server computer via a network for transmitting at least a portion of the at least one database to the at least one customer computer to populate a data mart database. Such warehouse or data mart database may be accessed with an application to provide customer data products.

### BRIEF DESCRIPTION OF THE DRAWINGS

The teachings of the present invention can be readily understood by considering the following detailed description in conjunction with the accompanying drawings, in which:

FIG. 1 is a network diagram of a de-identification and linkage system in accordance with an aspect of the present invention;

FIG. 2 is a block diagram of a de-identification process for a client computer configured in accordance with an aspect of the present invention;

FIG. 3 is a flow diagram of process steps of FIG. 2 in accordance with one or more aspects of the present invention;

FIG. 4 is a data flow diagram of an exemplary embodiment of converting original data to normalized data in accordance with an aspect of the present invention;

FIG. 5 is a data flow diagram of an exemplary embodiment of a normalized data record encoded to provide an encoded data record in accordance with an aspect of the present invention;

FIG. 6 is a flow diagram of an exemplary embodiment of a probabilistic record linkage process in accordance with an aspect of the present invention;

FIGS. 7A through 7C are flow diagrams of an exemplary embodiment of the probabilistic record linkage process of FIG. 6;

FIG. 8 is a data flow diagram of an exemplary embodiment of a match code process comparison of the probabilistic record linkage process of FIG. 6;

FIG. 9 is a table diagram of an exemplary embodiment of a match data output in accordance with an aspect of the present invention; and

FIG. 10 is a network diagram of an exemplary embodiment of a data distribution system in accordance with an aspect of the present invention.

To facilitate understanding, identical reference numerals have been used, where possible, to designate identical elements that are common to the figures.

### DETAILED DESCRIPTION

Prior to beginning a detailed explanation of aspects of the present invention, it is important to first set out some more information regarding de-identification and record linkage systems that have been used in the past. Generally these systems fall into one of two categories namely, deterministic matching and probabilistic matching. Deterministic matching refers to table-driven, rule(s) based matching where date fields are evaluated for a degree-of-match, and a match or no match resultant is assigned to each field comparison. Match and no match (yes's and no's) form match patterns that may be looked up in a table of rules to determine if compared data records match, do not match, or are in an undetermined state with respect to whether or not they match. Deterministic matching, like all linkage, is subject to false positive matches and false negative matches. False positive matches occur when matching records are linked together but actually belong to different entities, and false negative matches occur when records that should be linked together as they belong to the same entity are not linked.

Conventionally, it is believed that deterministic matching yields accuracy between approximately 60 and 95% of the time. It is conventionally believed that in deterministic matching, false negatives result between approximately 0 and 20% of the time and false positives result between approximately 1 and 5% of the time. Accordingly, it should be appreciated that deterministic matching has significantly high mismatched rates with respect to false negatives and false positives.

Probabilistic linkage, like deterministic matching, evaluates fields for degree of match, but instead of assigning a match or no match designation to a comparison, in probabilistic linkage a weight representing relative informational content contributed by a field is assigned to such a comparison. Individual weights are summed to derive a composite score measuring statistical probability of records matching. A user may set a pre-defined threshold as to whether a probability is sufficiently large as to consider a comparison a match or sufficiently low to consider that there is no match. Additionally there may be an interval in-between such upper and lower thresholds in order to indicate that probabilistically it was not possible to determine whether a match had occurred or not. Conventionally, it is believed that probabilistic matching yields accuracy between approximately 90 and 100% of the time with error tolerances set at conventional levels of between approximately 0.01 and 0.05. Conventionally it is believed that probabilistic matching false negatives occur between approximately 0 and 10% of the time and false positives occur between approximately 0 and 3% of the time. Accordingly, probabilistic matching has lower rates of false negatives and false positives than does deterministic matching.

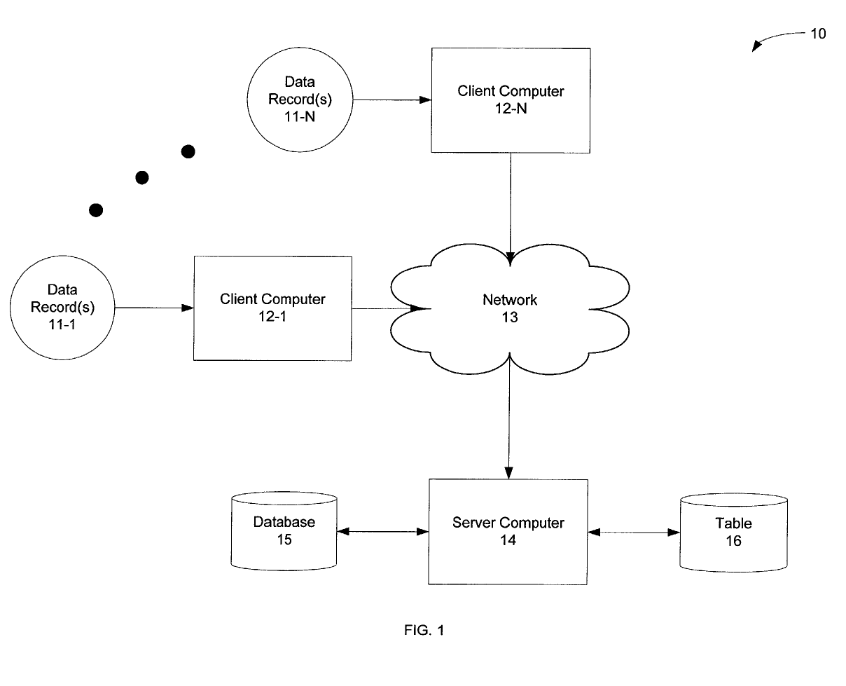

Referring to FIG. 1, there is shown a network diagram of a de-identification and linkage system 10 in accordance with an aspect of the present invention. One or more data records 11-N, for N a positive integer, are input to one or more client computers 12-N. One or more data records 11-1 is processed by client computer 12-1, as described below in more detail.

Data records 11-1 after processing by a client computer 12-1 are transmitted to server computer 14 via network 13. Network 13 may be a portion of the Internet, a private network, a virtual private network and the like. Client computer 12-1 is configured for de-identification of data records. Accordingly, processed data records 11-1 have been de-identified prior to transmission to network 13 from client computer 12-1. This is an important feature as content is often subject to intercept or viewing during transfer.

Multiple data records 12-N from multiple sources or client computers 12-N may be provided via network 13 to server computer 14. Client computers 12-N and server computer 14 may be any of a variety of well-known computers programmed with an applicable operating system and having an input/output interface, one or more input devices, one or more output devices, memory and a processor.

Server computer 14 is configured for probabilistic record linkage of de-identified data records from one or more data sources. Server computer 14 is in communication with database or table 16 and database 15. Table 16 and database 15 may be part of server computer 14 or coupled to server computer 14 externally, for example, directly or over a network. Table 16 indicates which master records are in database 15, and in this respect table 16 may be considered a portion of database 15. Table 16 is used to facilitate a record linkage process as described below in more detail.

Because records are de-identified as described below, not only is risk of breach of security reduced with respect to transmission from a client computer to a server computer, but risk is reduced at the server end too. Accordingly, distributed computing and scaling associated with a distributed computer system is facilitated.

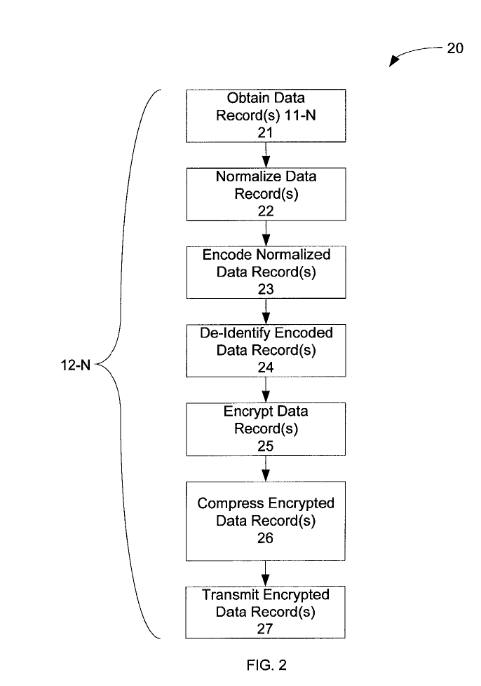

Referring to FIG. 2, there is shown a block diagram of a de-identification process 20 for a client computer 12-N configured in accordance with an aspect of the present invention. At step 21, client computer 12-N obtains or receives input of one or more data records 11-N. At step 22, data records obtained at step 21 are normalized. Normalization comprises identification and standardization of different formatting of numbers, variations in name spellings, detection of default values and extraneous text components, among others, as described in more detail below. Once normalized, data records are encoded at step 23. After encoding, such encoded data records are de-identified at step 24, including field-level one-way encryption. Such one or more de-identified data records may be put into a file and two-way encrypted, such as public-key infrastructure two-way encryption, at step 25 and compressed at step 26 for transmission from client computer 12-N to server computer 14 (shown in FIG. 1) at step 27.

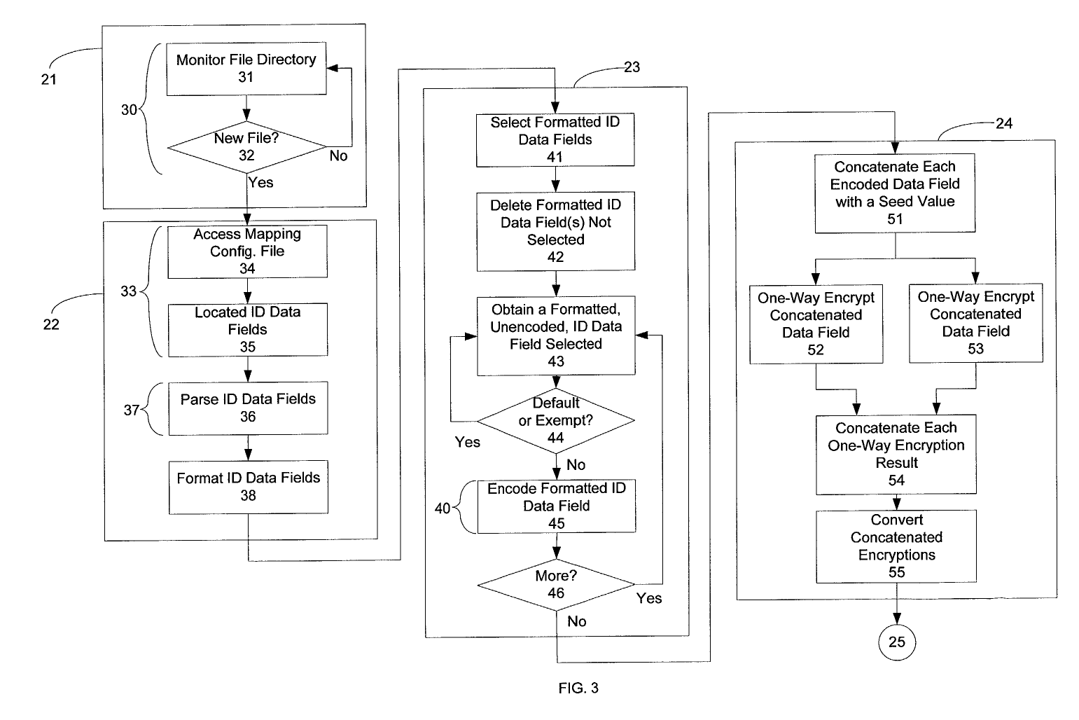

Referring to FIG. 3, there is shown a flow diagram of process steps 22, 23 and 24 of FIG. 2 in accordance with one or more aspects of the present invention. With continuing reference to FIG. 3 and additional reference to FIG. 2, normalization of one or more data records is described. At step 31, client computer 12-N monitors a file directory for a new data record file transmitted from client computer 12-N. At step 32, it is determined whether or not new file has been received. If at step 32 no new file has been received, monitoring continues at step 31. If a new file has been received at step 32, a mapping configuration file is accessed at step 34. Steps 31 and 32 may be performed at least in part with a file pickup program 30 resident on or operable by or from client computer 12-N. A new file comprises one or more data records, wherein such data records comprise data fields.

Accessing a mapping configuration file is done by a mapper program 33, which is initiated by file pickup program 30 in response to detection of a new file at step 32. Mapper program 33 uses a mapping configuration file to locate data fields having information pertaining to an individual's identity, namely, personally identifiable data fields or “ID” data fields, at step 35. After locating ID data fields, such located ID data fields are parsed at step 36. A parser program 37 may be used for parsing such ID data fields. After parsing ID data fields, such ID data fields are formatted at step 38. Formatting ID data fields may be done in accordance with predefined business rules and a predefined record format. Additionally, more data fields may be added to accommodate variations in ID data. Notably, programs 30, 33 and 37 may be any of a variety of well-known file pick-up programs, mapper programs, and parser programs, respectively.

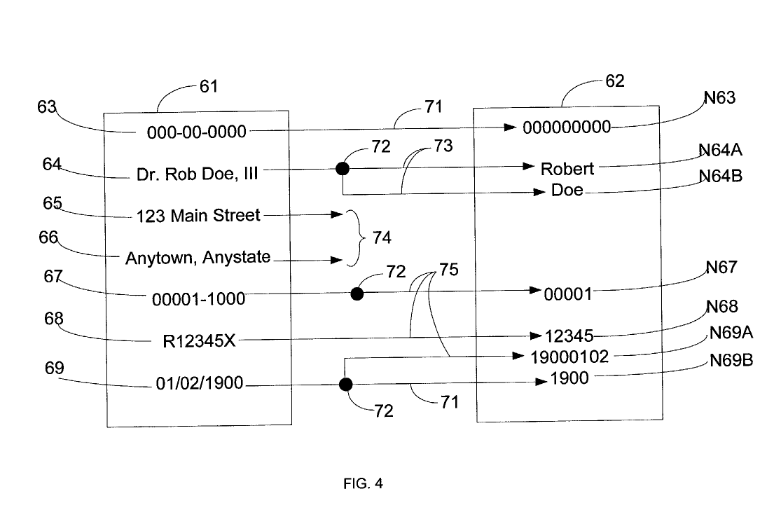

Referring to FIG. 4, there is shown an example of data flow processing from original data to normalized data in accordance with an aspect of the present invention. FIG. 4 is provided for purposes of clarity of description by way of example, and accordingly it should be understood that other personal identifier fields and normalization schemes may be used without departing from the scope of the present invention. Original data record 61 comprises identifier fields 63-69. Identifier field 63 is for social security number (“SSN”), identifier field 64 is for name, identifier field 65 is for street address, identifier field 66 is for city and state, identifier field 67 is for zip code, identifier field 68 is for health insurance identification number, and identifier field 69 is for date of birth (“DOB”). Though an example used herein is for the healthcare field, it will be apparent that other fields, as mentioned above, may be used in accordance with one or more aspects of the present invention.

Identifier field 63 is normalized as an exact match 71 in normalized data record 62. Name identifier field 64 is parsed 72 with sensitivity matching 73 to provide first and last names in associated first and last name fields in normalized data record 62. Notably, three additional fields may be added to accommodate hyphenated last names.

If a field was blank, it is assigned a standard default code. Pattern logic is used to identify client-specific default values and these values are converted to default codes. Source-specific defaults may be identified using frequency counts on values in person linkage attribute fields. Conventional examples of defaults are “9999” or “XXXX.”

Pre-editing steps are performed including removal of records where the last or first name is “test”, “patient”, “dog”, “canine”, “feline”, “cat”, for example. Records are removed where the first and last name combination is “John Doe” or “Jane Doe”. Invalid last names or first names are replaced with a default “invalid code” including “unknown”, “unavailable”, “not given”, “baby boy”, “baby girl”, “BB”, “BG” among others. Hyphenated last names are parsed into four separate fields so that all combinations of spelling on sourced data may be evaluated. These four fields are “first word only”, “second word only”, “first word, second word” and “second word, first word”. A social security number field is checked for nine digits and all characters not in the set [0-9] are removed. First name and last name fields are checked for more than two characters. All characters not in the set [A-Z, a-z] are removed. Notably, the example given is for the English language; however, it should be apparent that one or more aspects of the present invention may be localized for languages other than English.

Pattern recognition is used to remove prefixes such as Mr., Mrs., Ms. and suffixes such as Jr., Sr., I, II, III, 2^{nd}, 3^{rd}, 4^{th}, PhD, MD and Esq, among others. Sensitivity conversion 73 is used with data fields such as first names and last names to standardize a name to a common representation. For example, names such as Bob, Rob and Bobby are converted to a single character string representing “Robert”. Sensitivity conversion allows users to select a number of characters that need to match. So, if a character string were nine characters long, a user may set a level of the first eight characters needed to match. This facilitates misspellings and omissions being tolerated.

Street identifier field 65 and city identifier field 66 are dropped 74, and thus do not appear in normalization record 62. Accordingly, it should be appreciated not all personal identifier fields need to be normalized for purposes of de-identification and linkage. Zip code identifier field 67 is parsed 72 to the first five digits, all of which are check to ensure that they are in set [0-9]; otherwise zip code identifier field 67 is defaulted to invalid. Notably, the example is for an address in the United States; however, as is known other countries for example have zip codes with alpha characters, and accordingly not all characters in zip code identifier field 67 need to be in [0-9] for localization purposes. Zip code identifier field 67 is reformatted 75 for normalized data record 62.

Insurance number identifier field 68 is checked for more than two characters, and all characters not in set [A-Z, 0-9] are removed. Insurance number identifier field 68 is then reformatted 75 by removing all alpha characters. Date of birth identifier field 69 is checked and defaulted, such as to an “invalid” code, if not greater than Dec. 31, 1850. However, such a starting year need not be Dec. 31, 1850, but other years may be used. Year of birth is parsed 72 from date of birth identifier field 69. Date of birth information is reformatted 75 for normalized record 62, and year of birth is an exact match 71 for normalized data record 62.

Referring again to FIG. 3, after a record is normalized or formatted at step 38, normalized identification (ID) data fields are provided for encoding beginning with step 41. At step 41, pre-selected identifier fields are obtained. The number of identifier fields pre-selected or selected during processing will affect linkage. For example, if five identifier fields are selected for encoding, including social security number identifier field N63, last name identifier field N64B, first name identifier field N64A field, insurance identification number field N68 and date of birth identifier field N69, then accuracy in linkage is enhanced over using four identifier fields of such five identifier fields. Notably, it should be understood that some identifier fields contribute more to linkage accuracy than other identifier fields.

One or more identifier fields are selected at step 41 for purposes of encoding. At step 42, those formatted identification data fields that are not selected at step 41 are deleted. All data contained in personally identifiable data fields are permanently deleted from such fields if not selected for encoding. Notably, year of birth and a five-digit zip code are conventionally not considered personally identifiable data fields. Continuing the above example in conjunction with normalized record 62 of FIG. 4, identifier fields N67 and N69B would be deleted.

At step 43, a formatted and unencoded identifier data field, selected at step 41, is obtained. At step 44, it is determined whether or not the field obtained at step 43 comprises a default value or is exempt from encoding. If it does comprise a default value or is exempt, then another formatted and unencoded identifier data field selected is obtained at step 43. If it is not a default value or exempt as determined at step 44, then data in such formatted identifier data field is encoded at step 45.

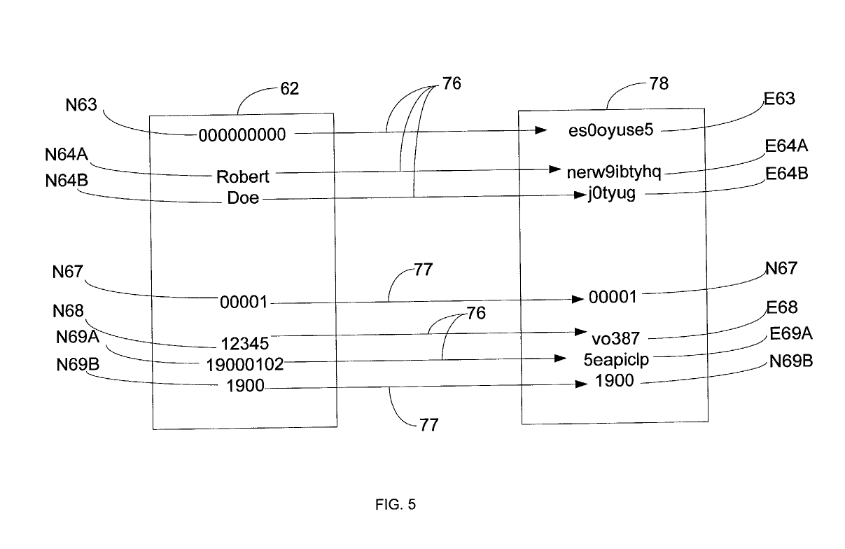

An encoding program is initiated to convert alphanumeric characters to a non-random character string based on a user-defined conversion formula. A conversion program 40 is used for this conversion. An example of such a conversion program is called Blue Fusion Data from Dataflux Corporation, though other conversion programs may be used in accordance with one or more aspects of the present invention. Conversion formulas may be set as exact conversion, namely, character for character. Encoding programs may be replicated for each data source installation, namely, client computer 12-N, to ensure that all data is treated the same for purposes of encoding. A non-random encoded character string replaces person identifiable data in data fields in a record as is illustratively shown in FIG. 5.

Referring to FIG. 5, there is shown a data flow diagram of an exemplary embodiment of a normalized data record 62 encoded to provide an encoded data record 78 in accordance with an aspect of the present invention. Optional encoding steps 76 are performed on normalized data fields N63, N64A, N64B, N68 and N69A to provide encoded data fields E63, E64A, E64B, E68 and E69A, respectively. Normalized data fields N67 and N69B are moved 77 without change to encoded data record 78. Non-person identification data fields may be left unencoded to retain for purposes of subsequent access original information content.

Referring again to FIG. 3, if there are no more data fields to encode, step 23 progresses to step 24 beginning at step 51 where each encoded data field is concatenated with a seed value. Optionally, a specific seed value is added to each encoded data field to form a new character string, namely, a seed identifier value, which may be a constant or a string dependent non-random value. Such a seed identifier value for each encoded data field is provided for one-way, field-level encryption, at steps 52 and 53, though one or more one-way encryption steps may be used. Though a single one-way encryption step may be used, each seed identifier value is subjected to two different one-way encryption algorithms. Examples of encryption algorithms that may be used include SHA-1, Snefra and MD5, among others. By way of example, at step 52, an SHA-1 encryption algorithm, which yields a 20-byte binary code, may be used. And, at step 53, an MD5 encryption algorithm, which yields a 16-byte binary code, may be used.

At step 54 encryption results from steps 52 and 53 are concatenated. It is not necessary that each encryption result be concatenated in whole. For example, all of the encryption result from step 52 may be used with a portion of an encryption result from step 53, or vice verse, or portions of encryption results from each of steps 52 and 53 may be concatenated together at step 54. Concatenation adds additional protection against security attacks, attempting to break encryption or replicate encryption results. For example, the full SHA-1 encryption value from step 52 may be concatenated with the last five characters of the MD5 encryption value from step 53 to form a single 25-byte binary code in step 54. At step 55, binary code from step 54 is converted to an alphanumeric character string, namely, a match code. A match code is created for each encrypted data field. Notably, other than normalization and a one-way encryption, other operations are not needed for purposes of de-identification. Thus, one-way encrypted or hashed identifiers of normalized personal data fields may be used as match codes.

Again, it should be appreciated that de-identification takes place at a client workstation prior to transmission, which facilitates protection of privacy. Moreover, after de-identification all personally identifiable data may be destroyed. So, for example, de-identified identifiers may be transmitted with other data for longitudinal linkage to other records. Such other information may be health records, financial information and other types of information. By longitudinal linkage, it should be understood that one or more records may be linked to a single master record. Moreover, if such one or more records are date coded, then they may be linked chronologically to from a chain of records.

With renewed reference to FIG. 2, after a data record or source data file contains one or more match code entries in data fields, it is compressed at step 25, encrypted at step 26 and transmitted at step 27.

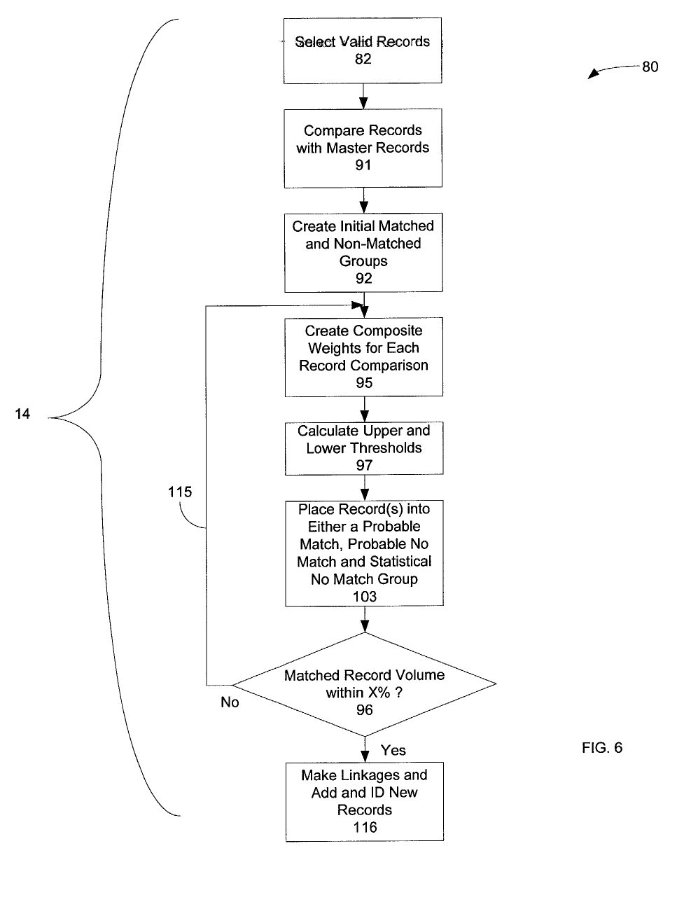

Referring to FIG. 6., there is shown a flow diagram of an exemplary embodiment of probabilistic record linkage process 80 in accordance with an aspect of the present invention. De-identified files received from a client computer 12-N are processed with probabilistic record linkage process 80 executable on server 14. Notably, multiple file types may be used. For example, in the healthcare industry, HCFA 1500 person-level care claims, UB92 hospital claims, Rx prescription claims and Consumer Survey records, among other file types, may be processed through probabilistic record linkage process 80. Moreover, each file contains records.

At step 82, records that do not have sufficient identifying information to match an individual record are sorted out from those records that do have sufficient information to have a possibility of being able to be identified to a record of an individual.

At step 91, those records having the possibility of being matched up at step 82 are compared with records from a master record list, such as from table 16 of FIG. 1. At step 92, results from step 91 are put into initial matched and non-matched groups using deterministic rules. Such initial sorting is used as initial or seed values, as described below in more detail. At step 95, individual or attribute weights are generated for each comparison resultant and are summed to create a composite weight or score for each record comparison.

At step 97, upper and lower threshold values are calculated. An upper threshold value sets a minimum probability for a probable match result. A lower threshold value sets a maximum probability for a statistical no match result. Between upper and lower threshold values is a region of probable no match.

With step 103, records are placed into either a probable match, probable no match, and statistical no match categories or groups. After a first iteration, probable match and statistical no match groups from step 103, instead of those matched and non-matched groups of step 92, are used to recalculate individual and composite weights for each record comparison at step 95, as explained below in more detail.

At step 96, records contained in one or more current groupings are compared to those contained in one or more prior groupings. If a “change in record grouping” results in excess of a determined percentage, X %, then process 80 at step 96 proceeds to branch 115. If, however, a “change in record grouping” results in equal to or less than X %, then process 80 at step 96 proceeds to step 116. At step 116, record linkages are made and new records are added to a master record database. By “change in record grouping,” it is meant movement of records between one or more groups of probable match, probable no match and statistical no match. Thus, process 80 is an iterative process, until match record volume is within a determined percentage of a prior iteration. A default value may be used on a first pass through process 80 to force recalculation of individual and composite weights using grouping from step 103 as opposed that of step 92.

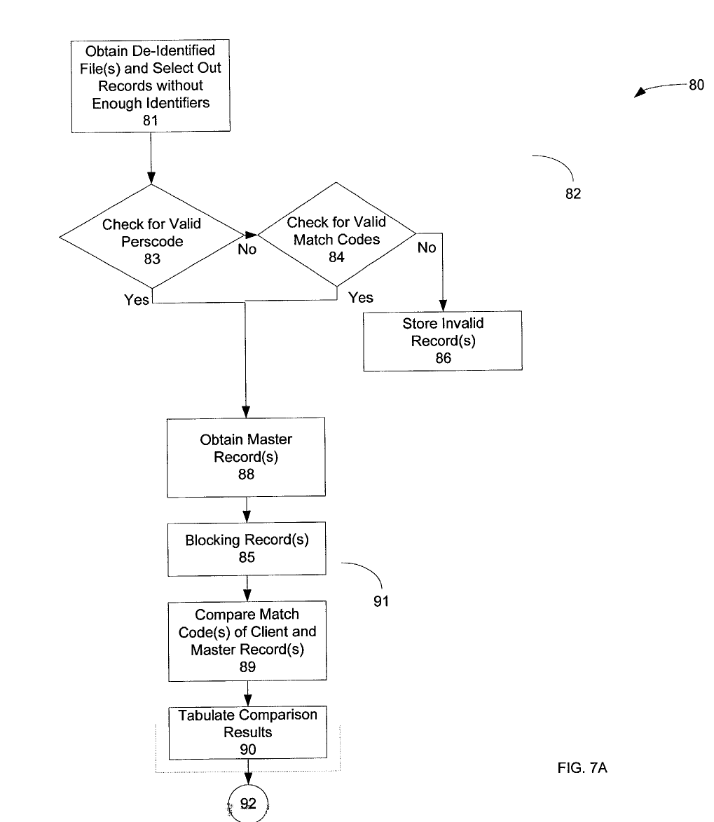

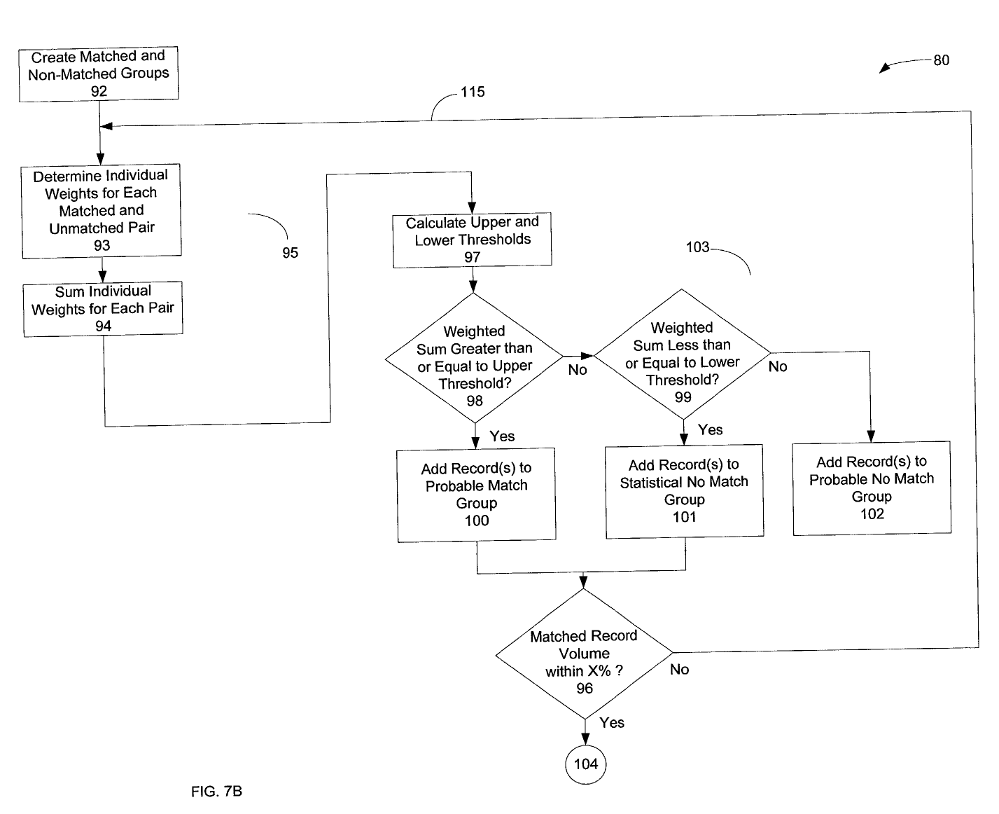

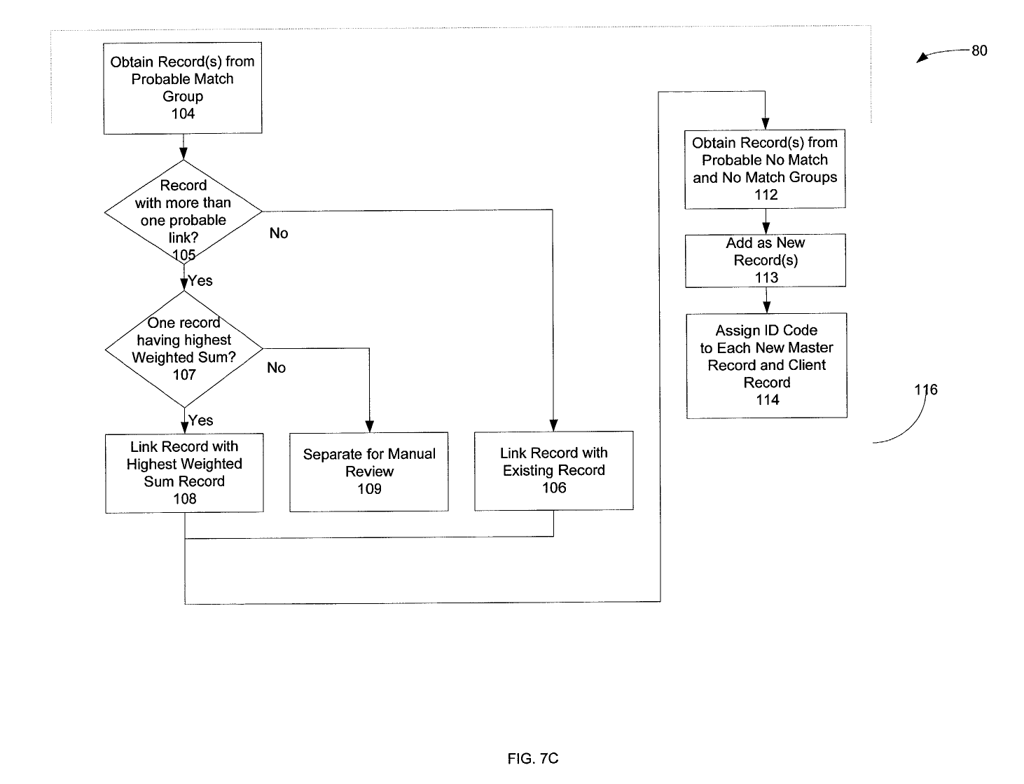

Referring to FIGS. 7A through 7C, there is shown flow diagrams of an exemplary embodiment of probabilistic record linkage process 80 of FIG. 6. At step 81, de-identified files are obtained, and those without sufficient identifiers to match up to unique individual record are selected out as described above. At step 83, a check for a valid encryption result (“match code”) of a social security number (“PERS code”) is made. If no match of PERS code match codes are found between a master record and a compare record, at step 84 a check for valid match codes, other than for a PERS code, is made. For example, all records are evaluated to determine if valid match codes exist for at least some number of the totals number of match codes. For example, a check may be made to make sure that valid match codes match for at least 3 of 5 possible match codes, such as a last name code (LN code), a first name code (FN code), a data of birth code (DBT code), a zip code and a insurance number code (MBID code).

If a record does not meet either criteria of step 83 or 84, then it is an invalid record and is stored at step 86. If a record meets either criteria at steps 83 or 84, such a record is sent for matching at step 88. A valid PERS code or sufficient number of valid match codes are provided from steps 83 and 84 to step 88, where master records are obtained.

At step 85, a blocking step is invoked. At step 85, record blocking is used to filter out records from those remaining after processing for sufficient identifying information. Record blocking acts as a filter to reduce the amount of record comparisons. For example, one or more of SSN or other identification number, date of birth plus gender, last name plus gender or first name, or street address plus last name may be used as database record filters to block those records that deterministically do not match from further comparison. For example, a gender field may not be de-identified for purposes of sorting a database into two distinct groups, namely, male and female. Thus, a record having a one gender type will not be compared against records in such a database having an opposite gender type. Another example, a de-identified SSN field of a record may be compared to other de-identified SSN fields of records in a database. If there is no de-identified SSN field match, then with respect to those records that do not match, no other fields for those records are compared.

At step 89, comparison of a set of match codes, or de-identified values, for each record is compared with a set of match codes on each record in master person table 16. It should be understood that master person table 16 is populated with de-identified records having match codes for purposes of comparison.

For a record and master person database or table 16, a positive match on each field is indicated as a “1” and a “0” designates that match codes do not agree. Moreover, if data is missing, a match cannot be determined, so both match and no-match values are set to “0”. Accordingly, after comparison of master records with match codes at step 89, a tabulation of the results of such comparison is done at step 90. Notably, step 90 may be considered a separate step or a part of step 92.

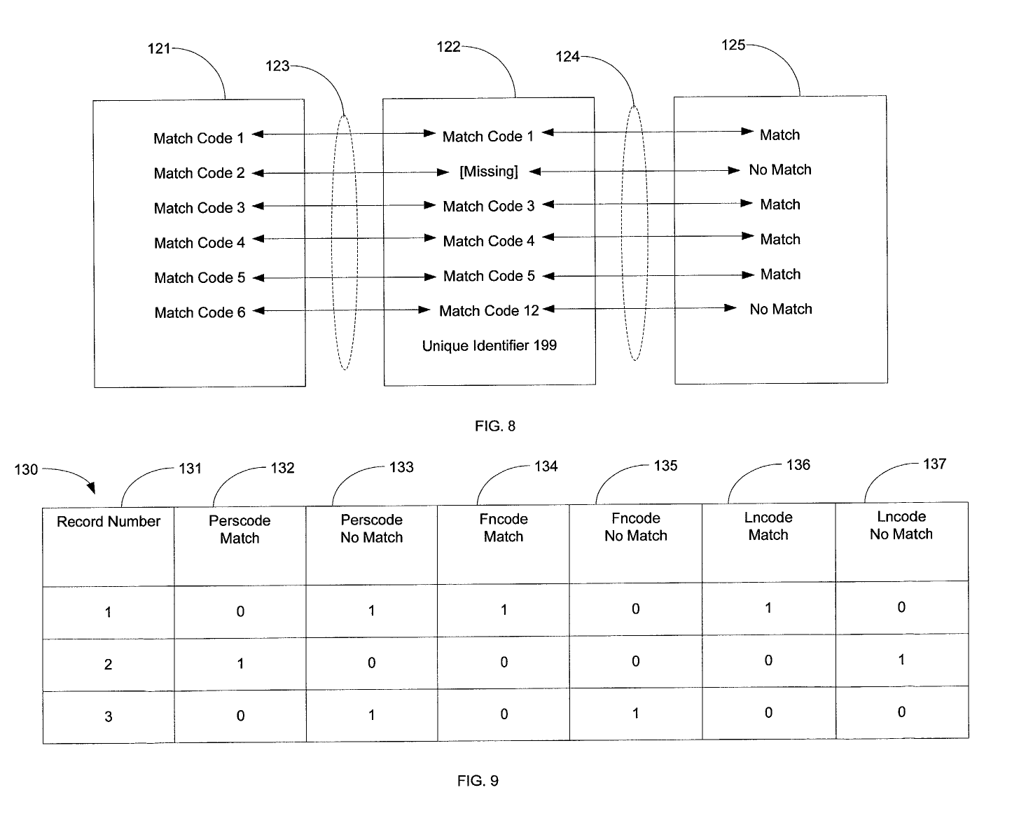

Referring to FIG. 8, there is shown a data flow diagram of an exemplary embodiment of a match code process comparison of process 80 in accordance with an aspect of the present invention. Subject data record 121 is newly submitted record having match codes 1 through 6. Comparison 123 is made with a master data record 122. It should be understood that new record 121 may be compared with more than one master record 122, such that a composite weighted score is used to determine which record is most likely the master record 122, if any, that new data record 121 matches.

As is illustratively shown, master record 122 has match codes 1,3,4,5 and 12, and is missing match code 2. Accordingly, results of comparison 124 may be tabulated to provide a match record 125 indicating match and no-match results.

Referring to FIG. 9, there is shown a table diagram of a table 130 of an exemplary embodiment of a match data output in accordance with an aspect of the present invention. For purposes of example, only a few match codes have been used; however, fewer or more, and certainly other match codes, may be used. Table 130 comprises record number column 131, PERS code match 132, PERS code no match 133, FN code match 134, FN code no match 135, LN code match 136, and LN code no match 137. So, for example, taking record number 2, there was a match for PERS code and a no match for LN code. As both the values for FN match and no match columns are “0”, it means that data was missing from first name data field, such that no match and no non-match condition could be determined.

Referring again FIG. 7B, at step 92, matched and non-matched groups of results are created from results obtained by comparison of match codes of client (new) and master records. At step 92, preliminary or initial match versus non-match groupings are created using deterministic rules. Notably, though deterministic matching is employed here in this exemplary embodiment, probabilities for probablistic matching may be used, or a combination of deterministic and probablistic matching may be used. All records not falling into an initial match group are put in an initial non-match group, and thus the two groups are mutually exclusive.

At step 93, individual weights for each match and unmatched pair are determined. Notably, though probablistic matching is employed in this exemplary embodiment, deterministic rules for deterministic matching may be used, or a combination of deterministic and probablistic matching may be used. Individual weights for matched and unmatched pairs of fields are calculated as:

0<Wₖ=log₂(mᵢ/uᵢ) (1)

for match pairs and

0>Wₗ=log₂[(1−mᵢ)/(1−uᵢ)] (2)

for unmatched pairs, where mᵢ is probability that components agree when there is a true match and uᵢ is probability that components agree when there is no true match.

Conditional probabilities mᵢ and uᵢ are calculated as:

mᵢ=P(Aᵢ|M) (3)

where mᵢ is the probability of a true match or the probability that the match value Aᵢ is positive given that the two records actually represent the same person (M), and

uᵢ=P(Aᵢ|NM) (4)

where uᵢ is the probability of a match due to chance or the probability that the match value Aᵢ is positive given that the two records actually do not represent the same person (NM).

At step 94, individual weights calculated for each match code pair of a new record and a master record, are summed to provided a composite weight or total weight for each record compared to a master record, namely for each record pair. Weight for each match code comparison takes into account probabilities of error and predicted value of each match code pair. Accordingly, some match codes may have greater weight than others. This composite weight determined by summing individual weights is termed “total match score.” Match codes that agree make a positive contribution to total match score, and match codes that disagree make a negative contribution to total match score. Conditional probabilities may be derived by a known parameter estimation methodology, an example of which is called the EM algorithm. Other parameter estimation methodologies, other than the EM algorithm, may be used including but not limited to the Expectation Conditional Maximization (EMC) algorithm. Total match weight (Wⱼ) is computed for each record comparison by summing all attributed weights, as:

Wⱼ=(Wₖ*Aᵢ)+(Wᵢ+Dᵢ), (5)

where Aᵢ and Dᵢ are match and no match values, respectively, for an iteration, Wₖ is an individual weight for a matched pair and Wⱼ is an individual weight for an unmatched pair.

After summing individual weights for each matched pair at step 94, at step 97 threshold values are calculated. Threshold values determine which record comparisons are considered a match, which are considered a statistical no match, and which are considered probable no match. Utilizing a methodology described in the EM algorithm, an upper threshold is calculated as,

Upper threshold=E(W_{j(unmatched)})+(z₁)(σ_{Wj(unmatched)}) (6)

And a lower threshold is calculated as,

Lower threshold=E(W_{j(matched)})−(z₂)(σ_{Wj(matched)}), (7)

where E(W_{j(unmatched)}) is an estimated mean of the distribution of composite scores among a statistical no match group, E(W_{j(matched)}) is an estimated mean of the distribution of composite scores among a probable match group, σ_{Wj(unmatched)} is a standard deviation of the distribution of composite scores of a statistical no match group, σ_{Wj(matched)} is a standard deviation of the distribution of composite scores of a probable match group, z₁ is an error tolerance for false positive matches, and z₂ is an error tolerance for false negative matches.

Total match scores that exceed an upper threshold are considered probable matches. Total match scores that are lower than a lower threshold are considered not to be matches. Total match scores falling in-between upper and lower thresholds are set as probable no matches. Error tolerance for false positive matches is approximately 0.001 to 0.01 and error tolerance for false negative matches is approximately 0.01 to 0.10.

After calculating upper and lower thresholds, it is determined at step 98 whether a weighted sum is greater than or equal to an upper threshold for each record pair. Those record pairs greater than or equal to an upper threshold are grouped into a probable match group at step 100. Those record pairs remaining that do not pass step 98 are processed at step 99 to determine whether they are less than or equal to a lower threshold. For those record pairs remaining that are less then or equal to a lower threshold, they are grouped into a statistical no match group at step 101. The remaining record pairs, namely, those record pairs that fall between upper and lower thresholds, are grouped into a probable no match group at step 102. These probable no-matched records may be analyzed separately to determine if there are any systematic errors that may cause a false “no probable match” designation.

Probable match and statistical no match groups from steps 100 and 101, respectively, are provided to step 96 to determine whether record volume change is within a predetermined percentage, as described above. It should be understood that in calculating probability weights after a first pass through a portion of process 80, probable match and no match groups 100 and 101, respectively, are used instead of initial match and non-match groups determined at step 92. In this regard, process 80 is iterative for determining weighted sums for record pairs. If at step 96 volume of record change is within X % of a prior record volume, then that records are processed at step 104. Values for X % are approximately in a range of 1 to 5 percent. Volume of record change may be viewed for either or both probable match group 100 or statistical no match group 101.

At step 104, records from probable match group 100 are obtained. At step 105, it is determined whether a record has more than one probable link with a record in a master person table 16. If such record has more than one probable link with more than one record in master person table 16, at step 107 it is determined whether one of these probable links has a higher weighted sum than the other probable links. If at step 107 one probable link does have a higher weighted sum, then that record is associated with that master record in master person table 16 having such highest link probability. By associated, it is meant that a record is linked with a master record. This association may be done by appending a unique identifier 199 to each master record when placed in master person table 16 to uniquely identify one master record from another, and then to append such master record unique identifier 199 to a client record for linkage. Accordingly, each record whether in client record database 15 or in master record database or table 16 is appended with a unique identifier 199. However, if no record has a highest weighted sum at step 107, then at step 109 such records are stored for manual review. If, however, at step 105 there is only one probable link to a record in master person table 16, then at step 106 such record is linked with such existing record in master person table 16. Notably, if there is an unmatched match code in a linked client record, each such unmatched match code is appended to the master recorded assocated with such client record in table 16. Client records in database 15 also have unique identifiers appended thereto. However, client records in database 15 are not automatically populated with new match codes from other client records.

At step 112, records from probable no match group, namely group 102, and statistical no match group 101 are obtained. These records from groups 101 and 102 may then be added to master person table 16 as new persons and assigned new identifier codes 199, for example as shown in FIG. 8. By adding records and assigning new and unique identifier codes, it is meant that for each record in these groups, a master record will be created containing match codes from such groups which become master match codes. A new unique record identifier code is generated and appended to each master record created, and this new unique record identifier code is appended to each client record. Notably, probable match records may be associated with an identification code 199 (shown in FIG. 8) of a master record for purposes of association or linkage. However, other methods of linkage may be used, including, but not limited to creating a table of addresses or locations for each record and all of its linked records. After adding these new records at step 113 and assigning new identification codes to each new master record in master record table 16 and each new client record in client record database 15 at step 114, process 80 ends.

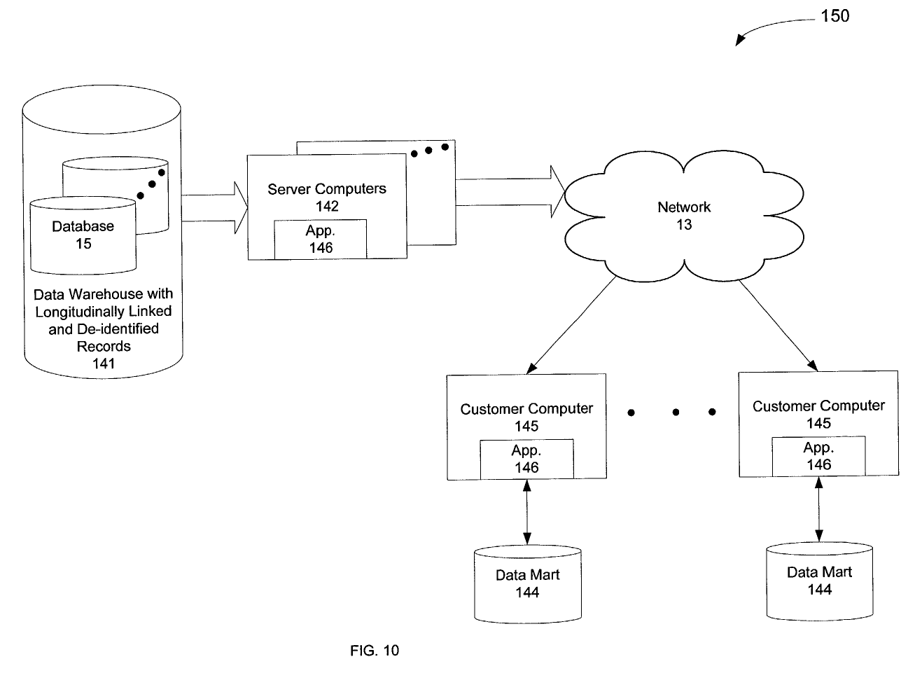

Referring to FIG. 10, where there is shown a network diagram of an exemplary embodiment of a data distribution system 150 in accordance with an aspect of the present invention, and FIG. 1, data warehouse 141 comprises longitudinally linked and de-identified records, as obtained from database 15, described above, or data warehouse 141 may comprise one or more databases 15. It should be noted that databases 15 comprises both master records and other records linked to master records. Each client record in database 15 may be linked to only one master record in table 16. These master records and linked records are de-identified as described above. One or more server computers 142 have access to records in data warehouse 141 for distribution via network 13 to one or more customer, such as subscriber or purchaser, computers 145. Computers 145, coupled to data mart databases 144. Data from one or more databases 15 is transported to create individual stores of some or all of records in data warehouse 141 in data mart databases 144. In this manner, such data may be ported for sale, license or other transaction for use, for example for any of the above-mentioned businesses or for public interest.

Additionally, one or more computer applications 146 of servers 142 or or customer computers 144 may have access to records in databases 141 or 144 and may use such de-identified, longitudinally linked records to provide person-level, anonymous information in the form of information products to one or more customers. An example of a computer application may be the organization and production of consumer profiles that describe in detail the type of persons who are more likely to buy Over the Counter or Prescription drugs and whether these persons are most easily marketed to by using television advertisements or print advertisements. A second example of a computer application may be the production and maintenance of a unique person identifier code different than the Social Security Number for use in the U.S. Census tracking process. A third example of a computer application may be the anonymous linkage of prescription and medical data to genetic databases to research the relationship between genetic makeup and traditional medical therapies. These types of information products are unique in that they can provide person level detail with minimal risk of personal identification.

Some embodiments of the invention are program products containing machine-readable programs. The program(s) of the program product defines functions of the embodiments and can be contained on a variety of signal/bearing media, which include, but are not limited to: (i) information permanently stored on non-writable storage media (e.g., read-only memory devices within a computer such as CD-ROM disks readable by a CDROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

Embodiments of the present invention have been described. However, it should be appreciated that other embodiments for use by hospitals, laboratories, financial institutions, telecommunication companies, insurance companies, retailers and marketing companies, to name just a few, may be used without departing from the scope of the present invention. Although various embodiments that incorporate the teachings of the present invention have been shown and described in detail herein, those skilled in the art can readily devise many other varied embodiments that still incorporate these teachings.

All trademarks are the property of their respective owners.

We claim:

1. A system comprising:
client computers having one or more data records, the client computers in communication with a network, the client computers configured to field-level normalize and one-way encrypt one or more fields of the one or more data records to provide one or more de-identified records; and
a server computer in communication with the network to receive the one or more de-identified records and in communication with a database, the database including one or more master records, the server computer configured to compare the one or more de-identified records with the one or more master records and to determine which records of the one or more de-identified records and the one or more master records are to be linked.

2. The system of claim 1 wherein the database is partially described by a table of master records.

3. The system of claim 2 wherein the table is for comparing the one or more de-identified records are compared with the one or more master records.

4. A method for de-identification of at least one record by a programmed client computer, comprising:
obtaining the at least one record, the at least one record having data fields;
normalizing at least a portion of the data fields; and
one-way hashing the at least a portion of the data fields to provide a de-identified record.

5. The method of claim 4 further comprising:
two-way encrypting the de-identified record;
compressing the de-identified record; and
transmitting the de-identified record.

6. The method of claim 5 further comprising encoding the data fields after normalization.

7. A method for de-identification of records by and at a programmed client computer, comprising:
providing records to the programmed client computer;
locating personal identification data fields in each of the records;
parsing the personal identification data fields;
formatting the personal identification data fields;
selecting at least a portion of the personal identification data fields formatted;
deleting any of the personal identification data fields not selected; and
one-way encrypting the personal identification data fields selected.

8. The method of claim 7 further comprising:
obtaining a mapping file; and
locating personal identification data fields in each of the records using the mapping file.

9. The method of claim 7 further comprising:
determining if the personal identification data fields selected are to be encoded; and
encoding the personal identification data fields to be encoded.

10. The method of claim 9 further comprising concatenating the personal identification data fields encoded with a seed value to provide seed value identifiers.

11. The method of claim 9 wherein the personal identification data fields are not concatenated with a seed value prior to the one-way encrypting.

12. The method of claim 7 wherein the one-way encrypting step comprises:
one-way encrypting with a first encryption algorithm the personal identification data fields selected to provide a first encryption result for each of the personal identification data fields selected; and
one-way encrypting with a second encryption algorithm the personal identification data fields selected to provide a second encryption result for each of the personal identification data fields selected.

13. The method of claim 12 wherein the one-way encrypting step comprises:
concatenating at least a portion of each of the first encryption result and the second encryption result for each of the personal identification data fields to respectively provide binary string identifiers for the personal identification data fields; and
converting the binary strings to alphanumeric strings to provide match codes.

14. A method for de-identification of records by a programmed client computer, comprising:
monitoring a file directory;
detecting presence of a new file in the file directory;
obtaining a mapping file for the new file;
locating personal identification data fields in records in the new file using the mapping file;
parsing the personal identification data fields;
formatting the personal identification data fields;
selecting at least a portion of the personal identification data fields formatted;
deleting any of the personal identification data fields not selected;
determining if the personal identification data fields selected are to be encoded;
encoding the personal identification data fields to be encoded;
concatenating the personal identification data fields encoded with a seed value to provide seed value identifiers;
first one-way encrypting the seed value identifiers with a first encryption algorithm;
second one-way encrypting the seed value identifiers with a second encryption algorithm;
concatenating at least a portion of each one-way encryption result from the first one-way encrypting and the second one-way encrypting corresponding to the seed value identifiers to respectively provide binary strings for each of the seed value identifiers; and
converting the binary strings to alphanumeric strings to provide match codes;
wherein de-identified records comprising the match codes are created at the programmed client computer prior to transmission to a server computer.

15. A method for linkage of de-identified records, comprising:
obtaining client de-identified records, the client de-identified records comprising field-level one-way hashed match codes;
providing a database of master de-identified records, the master de-identified records comprising field-level one-way hashed match codes;
comparing the match codes of the client de-identified records and the master de-identified records;
creating an initial match group and an initial no match group from the comparing of the match codes;
calculating individual weights for each comparison of match codes;
calculating a total match score from the individual weights;
calculating an upper threshold and a lower threshold;
placing each of the client de-identified records according to the total match score for each into one of a probable match group, a probable no match group and a statistical no match group;
repeating the calculating steps until change in record volume is within tolerance; and
linking at least a portion of the client de-identified records with the master de-identified records.

16. The method of claim 15 wherein the calculating steps are repeated using tabulations of the probable no match group and the statistical no match group.

17. The method of claim 16 further comprising adding the client de-identified records not linked with the master de-identified records to the database as new master de-identified records.

18. The method of claim 15 wherein the client de-identified records are from a plurality of data sources.

19. The method of claim 15 wherein the client de-identified records are created at a later date than creation of the master de-identified records.

20. The method of claim 15 wherein the linking is longitudinal linking.

21. A method for linkage of de-identified records, comprising:
obtaining client de-identified records, the client de-identified records comprising field-level one-way hashed match codes;
providing a database of master de-identified records, the master de-identified records comprising field-level one-way hashed match codes;
comparing the match codes of the client de-identified records and the master de-identified records;
deterministically creating an initial match group and an initial no match group from the comparing of the match codes;
calculating individual weights for each comparison of match codes of the client de-identified records and the master de-identified records;
calculating a total match score from the individual weights for each comparison of the client de-identified records and the master de-identified records;
calculating an upper threshold and a lower threshold, the upper threshold and the lower threshold in combination used to delineate a probable match group region, a probable no match group region and a statistical no match group region;
placing each of the client de-identified records according to the total match score for each into one of the probable match group region, the probable no match group region and the statistical no match group region to provide at least in part a probable match group and a statistical no match group;
comparing at least one of the probable match group or the statistical no match group to the initial match group or the initial no match group, respectively, for change in volume of records;
if the change in volume of records is not within a determined percentage, using the probable match group and the statistical no match group to calculate the individual weights; and
if the change in volume of records is within the determined percentage,
longitudinally linking the client de-identified records to the master de-identified records by appending record identifiers of the master de-identified records to the client de-identified records;
adding the client de-identified records not linked to the master de-identified records to the database as master records; and
appending the record identifiers to the client de-identified records added.

22. A signal-bearing medium containing a program which, when executed by a processor, causes execution of a method comprising:
obtaining at least one record, the record having data fields;
normalizing at least a portion of the data fields; and
one-way hashing the at least a portion of the data fields to provide a de-identified record.

23. A signal-bearing medium containing a program which, when executed by a programmed client computer, causes execution of a method comprising:
providing records to the programmed client computer;
locating personal identification data fields in each of the records;
parsing the personal identification data fields;
formatting the personal identification data fields;
selecting at least a portion of the personal identification data fields formatted;
deleting any of the personal identification data fields not selected; and
one-way encrypting the personal identification data fields selected.

24. A signal-bearing medium containing a program which, when executed by a programmed client computer, causes execution of a method comprising:
monitoring a file directory;
detecting presence of a new file in the file directory;
obtaining a mapping file for the new file;
locating personal identification data fields in records in the new file using the mapping file;
parsing the personal identification data fields;
formatting the personal identification data fields;
selecting at least a portion of the personal identification data fields formatted;
deleting any of the personal identification data fields not selected;
determining if the personal identification data fields selected are to be encoded;
encoding the personal identification data fields to be encoded;
concatenating the personal identification data fields encoded with a seed value to provide seed value identifiers;
first one-way encrypting the seed value identifiers with a first encryption algorithm;
second one-way encrypting the seed value identifiers with a second encryption algorithm;
concatenating at least a portion of each one-way encryption result from the first one-way encrypting and the second one-way encrypting corresponding to the seed value identifiers to respectively provide binary strings for each of the seed value identifiers; and
converting the binary strings to alphanumeric strings to provide match codes;
wherein de-identified records comprising the match codes are created at the programmed client computer prior to transmission to a server computer.

25. The method of claim 24 wherein the programmed client computer comprises a mapper program, a parser program, a formatting program and an encoding program.

26. A signal-bearing medium containing a program which, when executed by a programmed server computer, causes execution of a method comprising:
obtaining client de-identified records, the client de-identified records comprising field-level one-way hashed match codes;
accessing a database of master de-identified records comprising field-level one-way hashed match codes;
comparing the match codes of the client de-identified records and the master de-identified records;
creating an initial match group and an initial no match group from the comparing of the match codes;
calculating individual weights for each comparison of match codes;
calculating a total match score from the individual weights;
calculating an upper threshold and a lower threshold;
placing each of the client de-identified records according to the total match score for each into one of a probable match group, a probable no match group and a statistical no match group;
repeating the calculating steps if change in record volume is not within tolerance; and
linking at least a portion of the client de-identified records with the master de-identified records.

27. The method of claim 26 wherein the calculating steps are repeated using tabulations of the probable no match group and the statistical no match group.

28. The method of claim 27 further comprising adding the client de-identified records not linked with the master de-identified records to the database as new master de-identified records.

29. The method of claim 26 wherein the client de-identified records are from a plurality of data sources.

30. The method of claim 26 wherein the client de-identified records are created at a later date than creation of the master de-identified records.

31. The method of claim 26 wherein the linking is longitudinal linking.

32. A system comprising:
a data warehouse, the data warehouse comprising at least one database including master de-identified records and de-identified longitudinally linked records to at least a portion of the master de-identified records;
at least one server computer in communication with the data warehouse;
at least one customer computer;
a network configured to place the at least one server computer in communication with the at least one customer computer for transmitting at least a portion of the at least one database to the at least one customer computer to populate a data mart database.

33. The system of claim 32 wherein the at least one server computer or the at least one customer computer comprises an application configured to provide a data product from the de-identified longitudinally linked records.

34. A method for linkage of de-identified records, comprising:
obtaining client de-identified records, the client de-identified records comprising field-level one-way hashed match codes;
providing a database of master de-identified records, the master de-identified records comprising field-level one-way hashed match codes;
comparing the match codes of the client de-identified records and the master de-identified records; and
linking at least a portion of the client de-identified records with the master de-identified records using comparison of the match codes.

35. The method of claim 34 further comprising assigning identification codes to the master de-identified records.

36. The method of claim 35 further comprising appending the identification codes of the master de-identified records to the client de-identified records.

37. A method for transforming personal identifying information to facilitate protection of privacy interests while allowing use of non-personally identifying information, comprising:
receiving data on an individual including personally identifying information, de-identifying the data at a client computer including field-level one-way encryption, transmitting the de-identified data to a server computer for record linkage, and using match codes created for the data at the client computer to link records at the server computer.
